(19) United States
(12) Patent Application Publication
(10) Pub. No.: US 2009/0117415 A1
(43) Pub. Date: May 7, 2009

(54) Arrangement for supplying a fuel cell with recycled reaction gas

(75) Inventors: Klaus Leister, Weinheim (DE); Verena Huecker, Weinheim (DE)

Correspondence Address: Davidson Davidson & Kappel, 485 Seventh Avenue 14th floor, New York, NY, 10018, US

(73) Assignee: Carl Freudenberg KG, Weinheim (DE)

(21) Appl. No.: 11/991,443

(22) PCT Filed: Sep. 5, 2006
(86) PCT No.: PCT/EP2006/008640

§ 371 Date: Aug. 4, 2008

Related U.S. Application Data
(60) Provisional application No. 60/714,920, filed on Sep. 7, 2005.

(30) Foreign Application Priority Data
Sep. 5, 2005 (DE) 10 2005 042 407.4

(51) Int. Cl. H01M 8/00

(52) U.S. Cl. 429/12

(57) ABSTRACT

Arrangement (1) for supplying a fuel cell (2) with recycled reaction gas (3), comprising a humidifier (4) with a first inlet (5) for the reaction gas to be humidifed (3) and a second inlet (6) for the moisture carrier (7), a filter arrangement (8) being pre-connected to the first inlet (5) and/or the second inlet (6).

### TECHNICAL FIELD

The invention relates to an arrangement for supplying a fuel cell with recycled reaction gas, comprising a humidifier with a first inlet for the reaction gas to be humidified and a second inlet for the moisture carrier.

### STATE OF THE ART

Such arrangements are known in general. In the case of certain types of fuel cells such as e.g. polymer electrolyte membrane fuel cells (PEM cells), permanent humidifying of the fuel cell membrane is necessary to achieve the maximum degree of effectiveness. Humidifying takes place by enriching the gas supplied to the fuel cell with water, the enrichment taking place by means of a humidifier. For the humidifier to reach an optimum degree of effectiveness and the moisture transfer to be controllable, an even supply flow is required. For this purpose, a gas conveying facility is frequently connected in front of the humidifier. However, gas conveying facilities operating in surges are in existence such that the supply stream to the humidifier can not be homogeneous. Moreover, pressure surges may lead to premature wear and tear. Frequently, only a limited amount of structural space is available for the humidifier resulting frequently in an unfavourable, e.g. skewed or asymmetrical, supply stream.

### DESCRIPTION OF THE INVENTION

The invention is based on the task of providing an arrangement in the case of which the supply stream to the humidifier is improved.

To achieve this task, a filter arrangement is pre-connected to the first inlet and/or the second inlet. The filter arrangement has the form of a particle filter, e.g. of a non-woven material, and forms a pressure equaliser which results in smoothing of the flow. This arrangement is advantageous in particular in the case of mobile applications since mobile fuel cells are operated dynamically and consequently operationally caused pressure variations may occur; the same applies also to compact stationary facilities. Possible pressure surges of a pre-connected gas conveying facility are attenuated in the filter arrangement. By a smoothed supply stream to the humidifier, the transfer of moisture is improved such that a small structural space requirement can be achieved. The filter arrangement can exhibit a wire netting, woven fabric, perforated lattice or diaphragms. These facilities lead to a further improved flow apart from having a support effect for the filter arrangement. Preferably, the filter arrangement has the form of a particle filter. This is used to filter particles capable of leading to premature wear and tear or loss of effectiveness of the humidifier. In this case, the ambient air which is supplied to the fuel cell as reaction gas on the cathode side is purified, on the one hand, and the cathode off-gas forming the moisture carrier can also be purified, on the other hand. The cathode off-gas can contain contaminants from the fuel cell which are retained in the filter arrangement such that purified cathode off-gas is supplied to the humidifier.

The filter arrangement may comprise a chemical filter. A chemical filter filters e.g. acidic and/or basic gases and prevents premature wear and tear of the humidifier and the fuel cells by the effect of damaging gases.

The filter arrangement may comprise a layer of activated carbon. The filter arrangement then comprises a particle filter and an activated carbon filter which may be combined to form one filter unit. The further filter arrangement may comprise an activated carbon layer. In this case, the activated carbon forms an adsorption filter and/or an absorption filter, depending on the equipment. Activated carbon is suitable for filtering widely differing chemical components and particles. Instead of or additionally to activated carbon, other sorbents may also be provided in the further filter arrangement. These may act also by physisorption and/or chemisorption. Impregnated carbon, silicon dioxide, aluminosilicates, aluminium oxides or an ion exchanger, for example, are conceivable.

The filter arrangement may comprise a fine filter. By means of a fine filter, fine particulate and liquid components may be filtered from the medium to be purified. An activated carbon layer may be connected to the fine filter downstream and also retain activated carbon particles.

The filter arrangement may comprise an electrostatically effective filter layer. Fine particles can be filtered with an electrostatically effective filter material with a low pressure loss. As a result of the electrostatic interaction, the pores may be formed larger with the same filter performance than in the case of a non-charged filter material. Filter media may be arranged by simple means in the gas stream and are easily replaceable.

The humidifier can have the form of a membrane humidifier. In the case of membrane humidifiers, the moist stream of gas and the stream of gas to be humidifyed are separated by a membrane which is permeable to water. In principle, the transportation of moisture may take place by capillary forces or diffusion forces. Both mechanisms are sensitive vis-à-vis contaminants. During transportation through the membrane, interface phenomena of the membrane are very important. These are influenced by contaminants of the surface; for example, the hydrophilic behaviour and the wetting behaviour of the membrane change on contamination. Pores may be clogged by particles. Functional groups may be blocked by contaminants or noxious substances. In the case of a membrane humidifier, the water-containing waste air of the cathode side can advantageously be used for humidifying such that a separate supply of water may be omitted. Additionally, an improved noise reducing effect is obtained in combination with the filter arrangement as a result of the flow design and the surrounding membranes of the humidifier. In other embodiments, the humidifier can have the form of a spray humidifier. Spray humidifiers are advantageous if humidifying of the anode gas is to take place since the anode gas reacts in association with oxygen, e.g. atmospheric oxygen. In the case of spray humidifying, humidifying takes place by spraying liquid water, e.g. through nozzles. Condensed water from the cathode off gas can be used as the water. When using liquid water, in particular water obtained from the cathode off-gas, prior purification is necessary since contaminants may lead to the nozzles becoming blocked. On humidifying of the cathode gas which is formed from the ambient air, a purification is also necessary since contaminants from the ambient air may deposit themselves on the nozzles leading to operating disturbances in the humidifier.

The humidifier may comprise hollow fibres. Hollow fibres possess a very large surface such that a high humidifying performance can be achieved with a small number of hollow fibres requiring little space. In the case of the hollow fibres, the moist stream of gas, for example, is passed around the fibres and the other stream of gas, e.g. the one to be humidified, is passed along inside the fibres. In the case of hollow fibre humidifiers, a prior filtration is additionally advantageous since the hollow fibres have a small cross-section which can be blocked or destroyed by particles penetrating inside.

The arrangement may form a unit mountable beforehand. The module-type structure in the case of which a unit of filter arrangement and humidifier is combined before mounting into the fuel cells facilitates mounting of the fuel cells since fewer parts need to be mounted.

The arrangement may be arranged in a housing. The unit of filter arrangement and humidifier is mounted beforehand in a particularly compact manner in a housing as a result of which mounting is further simplified. Connections, e.g. tubes and hoses to connect the filter arrangement and the humidifier, can be omitted.

A gas conveying facility can be connected in front of the arrangement. By means of the gas conveying facility, an increase in pressure and conveying of the gas stream take place. Depending on the equipment of the gas conveying facility, pressure surges may occur which are attenuated in the filter arrangement connected in front of the humidifier. Membrane pumps are frequently used as gas conveying facilities since the medium to be conveyed is completely encapsulated in the case of these. However, pressure pulsations occur in the case of a membrane pump which are attenuated in the filter arrangement such that the flow supplied to the humidifier is homogeneous and, as a result, reaches and optimum degree of effectiveness and is satisfactorily controllable.

A pre-filter can be connected in front of the air conveying facility. The pre-filter prevents the penetration of particles into the gas conveying facility and the arrangement as well as premature wear and tear.

A sound absorber may be connected in front of the air conveying facility. Sound emissions which are caused in particular by the gas conveying facility are prevented by the sound absorber.

The reaction gas may form the cathode gas of the fuel cell. The oxygen-containing medium, e.g. ambient air the case of PEM fuel cells, is supplied to the cathode. Although the supply of water to the cathode side does not exhibit the effectiveness of the supply to the anode side, it is technically simpler since the cathode waste air can be utilised safely for humidifying.

The reaction gas may form the anode gas of the fuel cell. The fuel, usually hydrogen, is passed to the anode. In the case of PEM fuel cells, it may be necessary to humidify the anode side since drying out leads to an increased resistance of the membrane and consequently to a loss of performance. However, it needs to be ensured in this case that no oxygen is transferred into the reaction gas since oxygen is then capable of reacting with the hydrogen in an uncontrolled manner in the form of a hydrogen-oxygen reaction leading to the destruction of the fuel cell.

The filter arrangement may comprise a sensor facility. By means of the sensor facility, the state of the filter arrangement can be monitored and the parameters measured can be made available to an evaluation unit for controlling the humidifier or the fuel cell. During this process, the temperature in particular, the moisture and the flow rate of the fluid flowing through can be measured in a sensor facility. By means of these parameters, a decreasing filter performance of the filter arrangement and consequently a necessary replacement of the filter arrangement can be signalled.

### SHORT DESCRIPTION OF THE DRAWINGS

Some practical examples of the arrangement according to the invention will be explained in further detail below by way of the figures. These show diagrammatically in each case:

FIG. 1 the arrangement according to the invention for humidifying the cathode gas;

FIG. 2 an arrangement with an additional filter arrangement for purifying the cathode off-gas;

FIG. 3 an arrangement with a pre-filter and a sound absorber connected in front;

FIG. 4 an arrangement for humidifying the cathode gas;

FIG. 5 an arrangement as pre-mountable unit in a housing.

### EXECUTION OF THE INVENTION

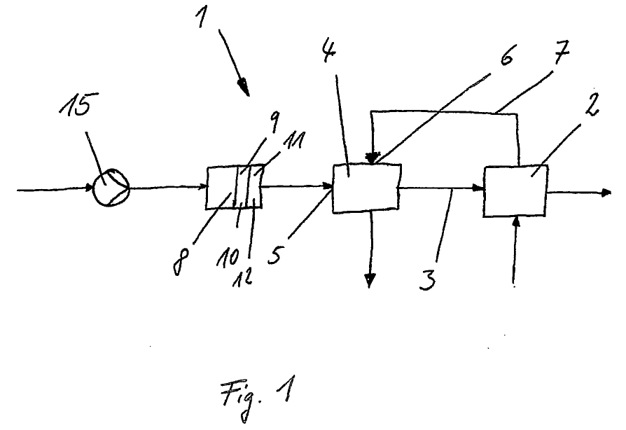

FIG. 1 shows an arrangement 1 for supplying a fuel cell 2 with recycled reaction gas 3. The reaction gas 3 is ambient air in the case of this design which is supplied to the fuel cell 2 on the cathode side. The arrangement 1 consists of a humidifier 4 formed as membrane humidifier with a first inlet 5 and second inlet 6. In the first inlet 5, the reaction gas to be humidifier 3 and in the second inlet 6 the moisture carrier 7 are introduced into the humidifier 4. The moisture carriers 7 is formed by the water-containing cathode waste air. In the case of this design, a filter arrangement 8 is connected in front in the first inlet 5. The filter arrangement 8 is formed as a particle filter and consists of a non-woven material formed as a flat surface. The filter arrangement 8 exhibits additionally to the layer of non-woven material a chemical filter 9 which is formed by a layer of activated carbon 10. Moreover, the filter arrangement exhibits a fine filter 11 which is formed by an electrostatically effective filter material 12. A gas conveying facility 15 formed as a membrane pump is connected in front of the arrangement 1.

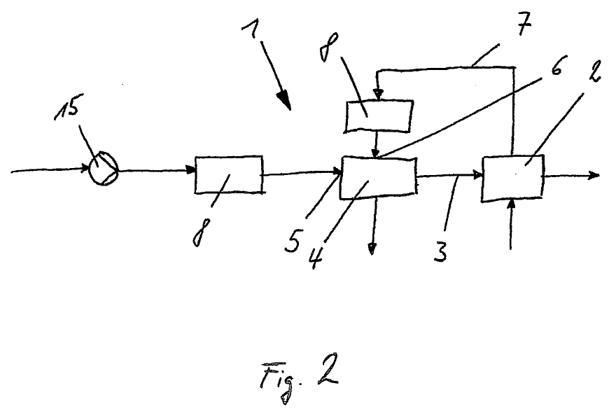

The arrangement 1 according to FIG. 2 corresponds to the arrangement 1 from FIG. 1, an additional filter arrangement 8 being connected in front of the second inlet 6 in the case of this design. The cathode off-gas which is formed by the moisture carrier 7 is purified by the additional filter arrangement.

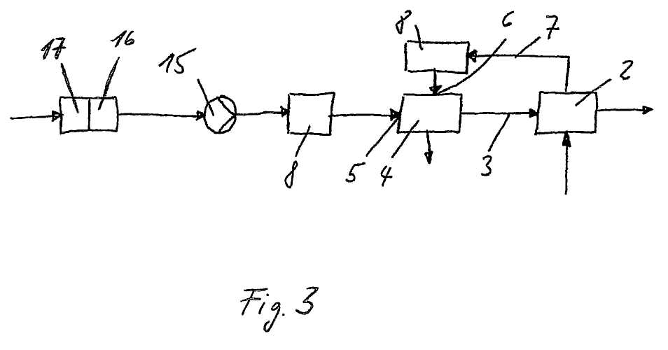

FIG. 3 shows an arrangement 1 according to FIG. 2, a pre-filter 16 being connected in front of the gas conveying facility 15, which pre-filter is combined with a sound absorber 17. As a result of the small space requirement, this arrangement is suitable in particular for mobile applications.

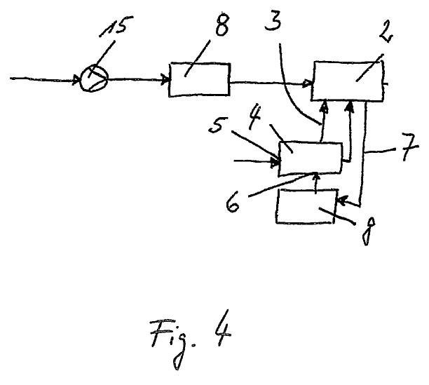

FIG. 4 shows an arrangement 1 for supplying a fuel cell 2 with recycled reaction gas 3. In the case of this design, the reaction gas 3 is hydrogen which is supplied to the fuel cell 2 on the anode side. The arrangement 1 consists of a humidifier 4 formed as a membrane humidifier with a first inlet 5 and a second inlet 6. The reaction gas 3 to be humidified is introduced into the first inlet 5 and the moisture carrier 7 is introduced into the humidifier 4 in the second inlet 6. The moisture carrier 7 is formed by the water-containing cathode waste air. In the case of this design, a filter arrangement 8 is connected in front of the second inlet 6.

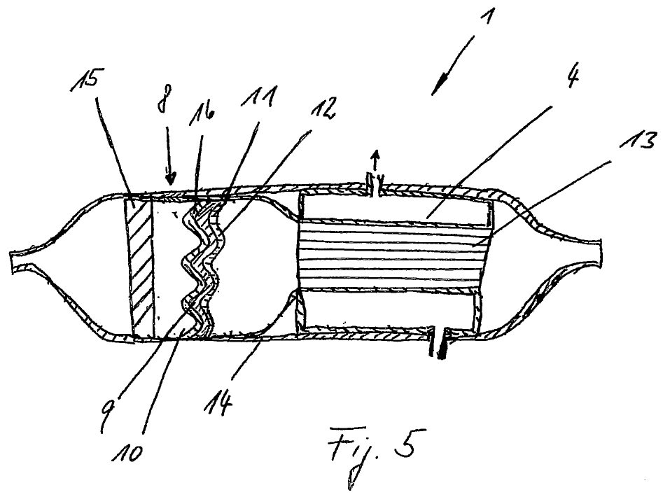

FIG. 5 shows an arrangement 1 which is formed as a pre-mountable unit. The filter arrangement 8 and the humidifier 4 are arranged in a housing 14. The filter arrangement 8 comprises a pre-filter 15 and a particle filter 16 which is formed as a pleated filter. A chemical filter 9 which is formed by an activated carbon layer is connected downstream to the particle filter 16. An electrostatically effective filter layer 12 which forms a fine filter 11 is connected downstream to the chemical filter 9. Downstream of the filter arrangement 8, a sensor facility 18 is arranged. The humidifier 4 has the form of a membrane humidifier, numerous water-permeable hollow fibres being present in the humidifier 4. This arrangement 1 operates also as a sound absorber.

1-16. (canceled)

17. An arrangement for supplying a fuel cell with recycled reaction gas comprising:
a humidifier with a first inlet for the reaction gas to be humidified and a second inlet for a moisture carrier;
and a filter arrangement connected in front of the first inlet and/or the second inlet.

18. The arrangement as recited in claim 1, wherein the filter arrangement comprises a particle filter.

19. The arrangement as recited in claim 1, wherein the filter arrangement comprises a chemical filter.

20. The arrangement as recited in claim 1, wherein the filter arrangement comprises an activated carbon layer.

21. The arrangement as recited in claim 1, wherein the filter arrangement comprises a fine filter.

22. The arrangement as recited in claim 5, wherein the filter arrangement comprises an electrostatically effective filter layer.

23. The arrangement as recited in claim 1, wherein the humidifier has the form of a membrane humidifier.

24. The arrangement as recited in claim 7, wherein the humidifier comprises hollow fibres.

25. The arrangement as recited in claim 1, wherein the arrangement forms a pre-mountable unit.

26. The arrangement as recited in claim 1, wherein the arrangement is arranged in a housing.

27. The arrangement as recited in claim 1, wherein a gas conveying facility is connected in front of the arrangement.

28. The arrangement as recited in claim 11, wherein a pre-filter is connected in front of the gas conveying facility.

29. The arrangement as recited in claim 11, wherein a sound absorber is connected in front of the gas conveying facility.

30. The arrangement as recited in claim 1, wherein the reaction gas forms the cathode gas of fuel cell.

31. The arrangement as recited in claim 1, wherein the reaction gas forms the anode gas of the fuel cell.

32. The arrangement as recited in claim 1, wherein the filter arrangement comprises a sensor facility.
